(19) United States
(12) Patent Application Publication
(10) Pub. No.: US 2008/0091606 A1
(43) Pub. Date: Apr. 17, 2008

(54) Proprietary encapsulated session container with embedded features for a post transferred option for electronic commerce along with a system for distribution and user access

(76) Inventor: William Grecia, Brooklyn, NY (US)

Correspondence Address: William Grecia, 932 East 79th Street, Brooklyn, NY, 11236, US

(21) Appl. No.: 11/548,918

(22) Filed: Oct. 12, 2006

(51) Int. Cl. H04L 9/00

(52) U.S. Cl. 705/51

(57) ABSTRACT

A unique proprietary system of commerce and distribution which uses host proprietary file containers and a proprietary client to author, serve, and access sub file containers contained within. The file containers are marked with a version number and a random number for processes related to traditional software application like updates and upgrades, all while retaining a single file proprietary form. Users can transfer file conditioners with the added stability of a embedded download manager that ensure a end user receive a preview capable file container before having the option to purchase access rights as set by the providing content owner. With the capability of a server in the proprietary client, content owners and users can transmit and access file containers within a proprietary community using embedded connection clients comprising instant messenger sub client, a peer to peer sub client, and direct access to an ftp remote server as a backbone to the proprietary community. Content owners can allow affiliates to enjoy the benefits of earning money through micro payments with the hosting commitment of their files.

### PATENT REFERECES

U.S. Pat. No. 5.675.734 October 1997 Hair

U.S. Pat. No. 5,966,440 October 1999 Hair

U.S. Pat. No. 7,103,261 September 2006 Grecia

### OTHER REFERENCES

“The definition of term proprietary” internet link http://www.pcmag.com/encyclopedia_term/0,2542,t=proprietary&i=49867,00.asp

### DESCRIPTION

1. Field of the Invention

The invention presented here relates to methods of digital distribution of eletronic files. Buyers of digital multimedia content are forced to pre pay for the right to transfer digital content without a one hundred percent guarantee of a complete successful transferring session. Common practice for digital file delivery and digital payment methods require content owners to host their content with third party companies called digital stores or administrative digital commerce gateways. Content owners must pay monthly fees with the services for a limited allotment of digital file space to host their digital files. Once buyers acquire digital content, they are forced to manually maintain relating multimedia content and need to author a play list of multiple relating files. The invention introduced here is a new method for buyer and seller digital exchange correcting several problems presented by prior art. Content owners can now host and serve multimedia and data content in a singular secure proprietary digital encapsulated container file. Content owners can set their preferred price of the digital containers for commerce transaction served to the internet directly from their personal computer using an interactive software client. Buyers can successfully execute a transfer process with the use of a download manager and verify the integrity of the data to the source before payment is rendered. Buyers and sellers have options to transfer data contained in the digital containers to physical recordable media or virtually use the encapsulated container file in embedded systems. The invention details this method of commerce and distribution by using processes comprising metadata, broadband database recording, broadband client to client communication, and multiple simultaneous sources.

2. Background of the Invention

The prior art referenced to this invention explained methods of prepayment without the guarantee of successful delivery of content rendered. This method of “payment before delivery” can offer many problems and hassles for content providers and consumers. Such example of a problematic exchange between a buyer and a seller using the prior art is the possibility of system failure and disconnection from a connected source. In such an event, a consumer would need to make grueling communication attempts to a content owner, and the content owner would need to verify and trace proof of payment. The prior art takes no reference to a licensing rights database with record of user ownership after a paid transaction with means of recovering another transfer of paid goods from the same or similar source in result of a system failure. Another issue with the prior art is the need to transmit and verify multiple files as transferred as the result of a single transaction. The prior art fails to explain a method of fulfilling a pre paid consumer transaction with a fail safe method of transferring huge files in excess between 1 megabyte to 1000 terabyte as relative to modern and future needs. A content owner currently do not have the power to edit, change, or improve previously exchanged content in any way once a transaction has transpired. Today, many resources are available for content owners to sell digital goods to buyers over dedicated networked data connections. Popular digital commerce can be found in the form of auction sites, music and video selling websites, and electronic document offerings such as e-books. These options have a common dependency on third party website known as the “host” to retain all digital files locally on the “host” owned and operated central computer system. When a content owner wants to sell digital goods, they will follow the method of steps comprising; finding a company to host their digital content; paying a monthly or yearly fee for the company to host their digital content; paying a service fee to the hosting company for every electronic payment transaction; receive their revenue from the company based on the company payment policies and rules. When a content owner choose to sell multimedia digital content, most popular audio and video digital commerce sites offer limited quality compressed versions of higher quality sourced content and may reject a content owner's material based on quality assurance. Content owners that choose to sell their multimedia digital content on “pay and download per track” powered hosts face price fixing and no ability to create custom and preferred pricing for their legally owned copyrighted works. The methods explained within the prior art do not explain and has not evolved to answer the issues expressed in this section of this document. The invention provided here is focused on resolving these issues that content owners and consumers are challenged with that offers a solution to issues raised by the prior art. This invention further document a unique solution solved by the inventor, presenting the capability for content owners to create a proprietary encapsulated digital file container used to store and deliver digital assets to multiple sources within a singular container host utilizing a download manager to ensure an exact clone of the original source is rendered before a requirement for payment is rendered.

### SUMMARY OF INVENTION

Technology is advancing at the rate of express growth and content owners and content buyers need a system of distribution and commerce that reflect our current times and the flexibility to adapt to future demands. Before the invention of this system, content owners relied on third party data host to administer their data for a fee. Content buyers are forced to “pre pay” for content that is not fully guaranteed for delivery and the hassle of managing multiple files separately from a related purchase. This invention has created a system where content owners can host files directly from their location without the dependency of a third party now making such a relationship optional. The invention also ensures that an end user is not required to “pre pay” to receive and use received files with preview features installed giving the user an option to pay or known as “optional post pay”. The invention in this document presents the operation of working with multimedia files not as individual non proprietary assets, but within a single proprietary container file with similar characteristics and features as traditional computer software with version numbers allowing update and upgrade of assets contained. The prior art in reference to this do not present a solution based on download management, post transfer optional payment, wireless communication, and proprietary file containment.

### DETAILED DESCRIPTION

The system of commerce and distribution of this invention comprise several key elements that work together to deliver a complete solution. The key elements used for this invention comprise a proprietary interactive application which can gather, manage, and author digital files for conversion to a proprietary encapsulated digital file container. The encapsulated digital file container is managed by an embedded metadata file which keeps a detailed record of binary data. The metadata file keeps a digital diary of key information that is used to reference and validate the authenticity of the encapsulated digital file container, and information relating to the creator of the file. The metadata primary elements of data used for this invention is the author of the file micro payment related email address, serving computer ip address, a random number generated by the client used for authoring, and the author's system password. The data that comprises a “host” file container are files that are first “wrapped” inside of a sub file container. For example, if a file container is created to hold a sequence of playback multimedia binary files, the sequence would probably be similar to; 1) video binary; 2) video binary; 3) embedded html code; 4) bitmap picture file; 5) video binary; 6) flash file. Inside of the host file container, each of the six files mentioned above would be “wrapped” in its own container file before becoming and enclosed asset of the host container file. The reason the why inventor chose this method is to allow each asset to hold a version number, a random number, and a cycle redundancy code (crc) within the control metadata embedded into each file container. The benefit of such structure is the ability to update and upgrade features to resemble and employ the characteristics of traditional software applications. Updating features work with the containers by referencing the version number in an end user transferred metadata file with the current file on the content owner's server at the time the end user starts their client. In the even a new version of a file container is available; the end user will have a choice to update or not to update. The content owner can set a metadata “flag” which calls for a mandatory update of a previously distributed file container. In the event of a mandatory update, the file container will update as a background process on an end user's computer system. In the process of a file container update used in this system, the sending and receiving client will compare both the new version of the file and the old version of the file by verification of metadata contents. This is also considered the process of syncing. The higher version numbered file container has the administrative rights to send data in this exchange. The older version number file is the receiving file in this exchange. Once the clients determine which of the inner containers need to be added and or subtracted, the process commence fully updating the old version of the file container with the assets needed to upgrade the host container to the currently served version of the host file container. Once an end user has obtained a file container from a content owner, they can view the contents of the file using a proprietary file container viewer. The end user also has an option to create an optical binary transfer of the file container contents for use with popular electronic devices. The content owner can set a price for the file container using the embedded metadata to hold the content owner's email information for micro payments. Embedded into the content owner's prepared file container are several key informational items. These items include the authoring computer IP address, the author's system password, the author's micro payment related details and a random number. The IP address is used to keep use of “mother” project files proprietary to the original computer it was created on. The term “mother” in reference to a master project file wherein “children” versions are created as tailored replicas of the “mother” for distribution task. The author system password is a unique and personal password to the author using the authoring and serving client to create file containers. At the installation stage of said client, the author is asked to create a system password for use with the system. Once the system password is set, it will be included in the metadata file of each file container created hereto. The reason for a system password feature is to ensure a fail safe method to unlock content access on an end user client in the event of an unsuccessful payment message relay used to unlock the file container after a payment has been rendered. The author's micro payment details are included in the file container's metadata file for reasons of copyright and intellectual property integrity. Said method of micro payment details ensure that content owners authoring a file container is reminded to use owned material and not unauthorized content in the event the original content owner will have easy access to information by way of a special metadata file viewer of finding the offending party. The random number feature is another security measurement taken by the inventor to ensure the micro payment email addressed used for this task is valid. When an author is ready to prepare the session file container for distribution, the client will ask the author to enter the relating micro payment email address at which time the client will email a random number to the micro payment email address entered. Random numbers of this system are unique is generation using variables comprised of numbers and letters in sets produced at random of at least five characters and up to twelve characters ensuring that no two numbers are never the same on any client in a local area network. Once the author receives the random number, they can enter it into the client which will proceed to give access to the ability to set a preferred micro price. The micro payment referred email address used in the random number scheme is now embedded into the pricing form and not changeable by the author. The authoring client used to produce file containers has a rich selection of features used to tailor each container creation as needed by the content owner. The author can set burn rights, update seek times, website links, magnet links to other file containers on a network, a html and url sequencer list, and contact information. The term generally associated with preferable options offered to an end user is called “flags”. The author can set an amount of burn rights offered in connection to the file container and offer “blocks” of burn rights for a fee. The author can set the seek time that a file container will look for an update from an end users client. The seek options are comprised of; weekly, daily, and with every startup of a user client. The end user can also adjust the parameters set for update seeking. The author can set a link to their internet website and popular hosted bogging networking sites. The author can add a list of magnet links to other file containers that are available for transfer. Magnet links can offer two sources of transfer locations which are the author's serving computer terminal and a third party web host. The author can include an html and url sequencing list of items to play streaming media within the client. The list places html code and url links in progressive sequence with the option of an embedded api working with the source of the streaming content to import metadata information within the client's interface. The author can include contact information such as an email address and a telephone number.

### Contents Contained in a File Container

The files contained in a file container are a copied collection of files used to produce a project or media compilation inside of an interactive computer based client for reason of structured playback on logical areas, removable memory locations and recordable media. The readability of a file container contents can be accessed from the file container direct by transferring the file to the media location as a proprietary file or encode the contents contained conforming to said media's standard specification for data structures. An example of a non standard format where this is true is in reference with the data structure of the art described in the inventor's established USPTO patent number 7103261. An example of logical areas represents a local or remote hard drive or system of clustered hard drives. An example of removable memory locations referenced for this invention comprises flash media cards, smart media cards, and sd media cards. An example of transferable recordable media represents compact disc recordable, digital versatile disc recordable, blue ray laser recordable media, holographic recordable media and universal disc media. Binary files included in a file container construction is comprising: a binary avi file; a binary mpeg file, a binary vob file, and binary dv file, a binary dvix file, a html file used for streaming media; a url internet link used for steaming media, a flash file; a shockwave file; binary picture files; a binary wav file; a binary aiff file; a binary mp3 file, a binary flac file; a magnet link; a torrent file; and a ftp link. Metadata information contained in a file container is comprising: instant messaging screen names; authors system password; authors ip address; authors micro payment related information; burn rights; lyric data; version numbers; random numbers; database access information; reference to a performance log; local picture data with at least 16 colors; and user defined custom data. The file container can have an option to self execute within a proper self executing command that delivers both the file container and a copy of the client needed to open the file due to the proprietary nature of the structure. Definition of the word “proprietary” in relation to the file container mentioned whereto;

Definition of: proprietary;

Private. Proprietary hardware and software are owned and controlled by a single organization or individual. Contrast with open.

### Download Management

The client used to serve and transfer file containers embed a download manager to ensure the completed task of data transfer before use and optional payment. The range of applicable equation equals a range of 1 (one) kilobyte to 1000 (one thousand) terabytes. If a user decided to transfer the maximum equated variable, at a data rate according to the standards currently available in reference with the date of this document would be 10 (ten) megabits per second (10 mbps). The resulting sum is equal to 222222 hours, 13 minutes, and 30 seconds. A file container's metadata file will record and keep record of a packet buffer and completed file sizes to keep track of received and requested data units in a cycle of block of at least 2048 sector bytes and above within the system utilizing a receiving client. In an event of such an extreme task, the system of download management explained in this document will manage start, stop, and resume functions related to interruptions in a transferring connection, power failure, system malfunction, and user error. Such promised disabilities are factored by observation of this process reliance on third party holders of power supply, data transferring services, server maintenance, and bad weather related disruption of service. If such a task is ever executed to such an extreme, the invention set forth in this document has covered the process of full transference of data before a requirement of an optional payment is rendered to the receiving party even after 25 years after initiating the transfer.

### BRIEF DESCRIPTION OF THE DRAWINGS

The drawings included in this document represent flow charts used in reference with actual development of an interactive client in support of which:

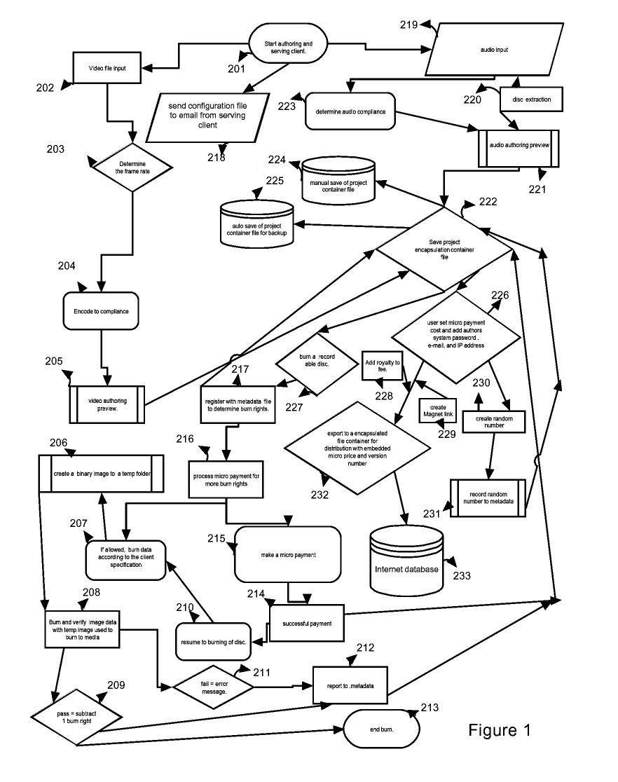

(1) FIG. 1 is a pictorial flow chart which explains the process of preparing a session of data flow and preparation of a proprietary file container;

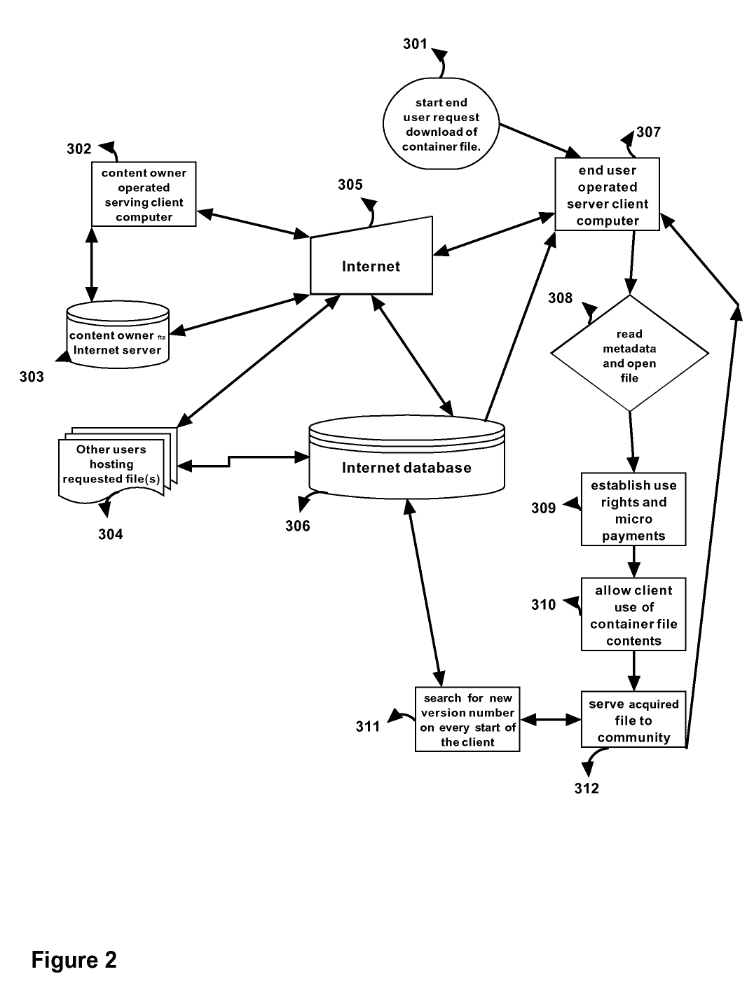

(2) FIG. 2 is a pictorial flow chart documenting the process of binary data and metadata connectivity to multiple nodes of transfer agents and communications to a simultaneously connected community or private internet dedicated database, with optional means of micro payment and serving task of the received container;

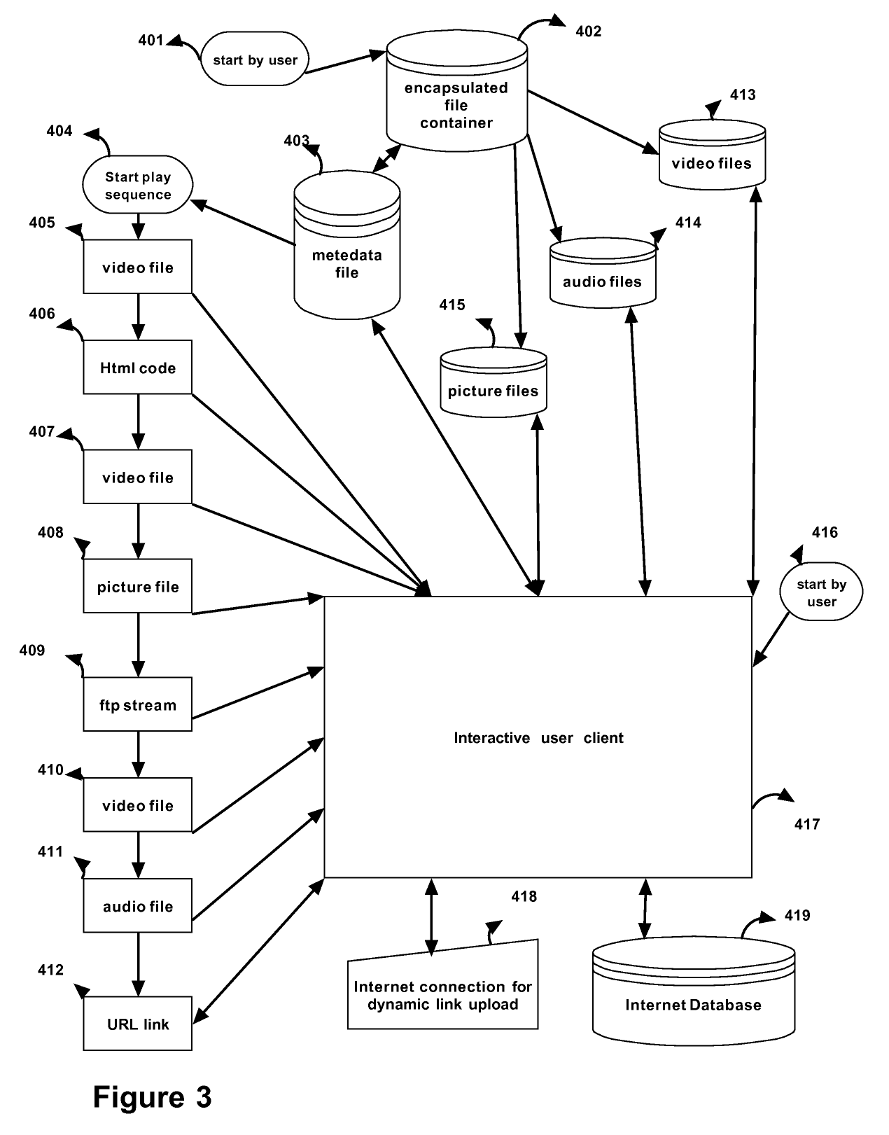

(3) FIG. 3 is a pictorial flow chart documenting the process of metadata interaction of a file container with the proprietary capable reading client and the sequencing steps implemented to produce a data flow from the binary assets contained in the sub file containers;

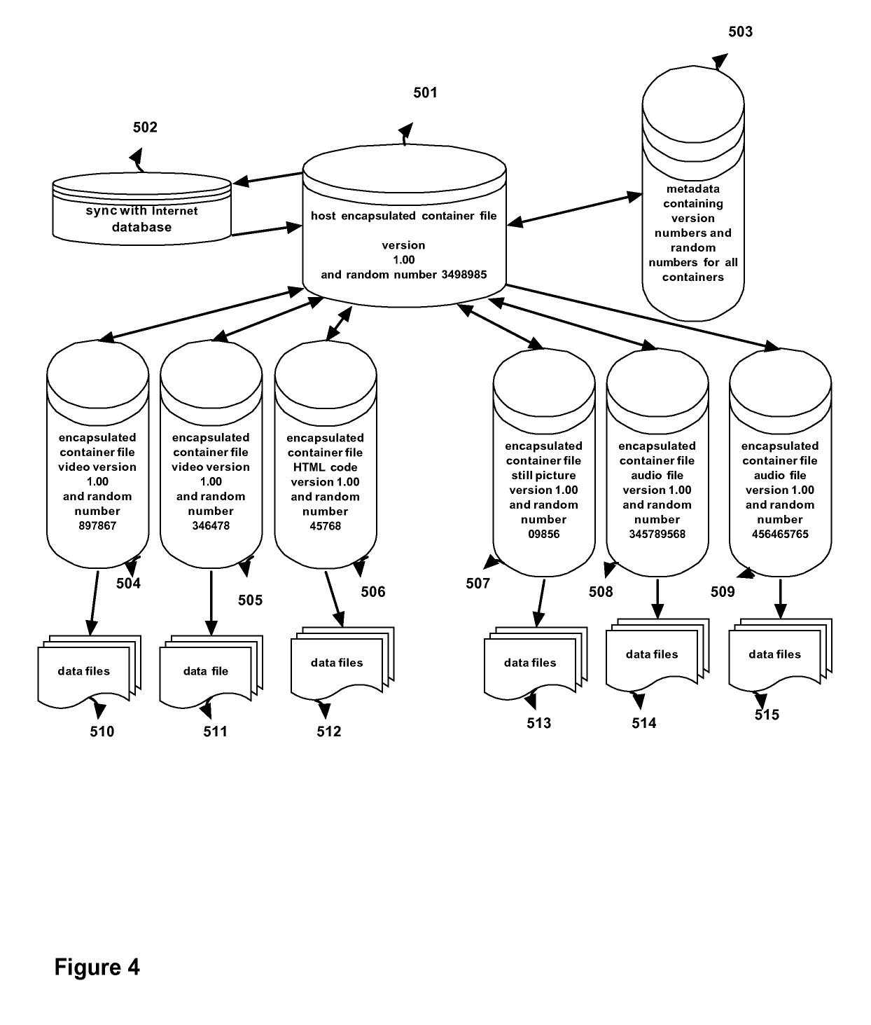

(4) FIG. 4 is a pictorial flow chart documenting the structural relationship of a host proprietary encapsulated file container and sub proprietary containers held within, showing use of version numbers and random numbers which is the catalyst for the update features; and

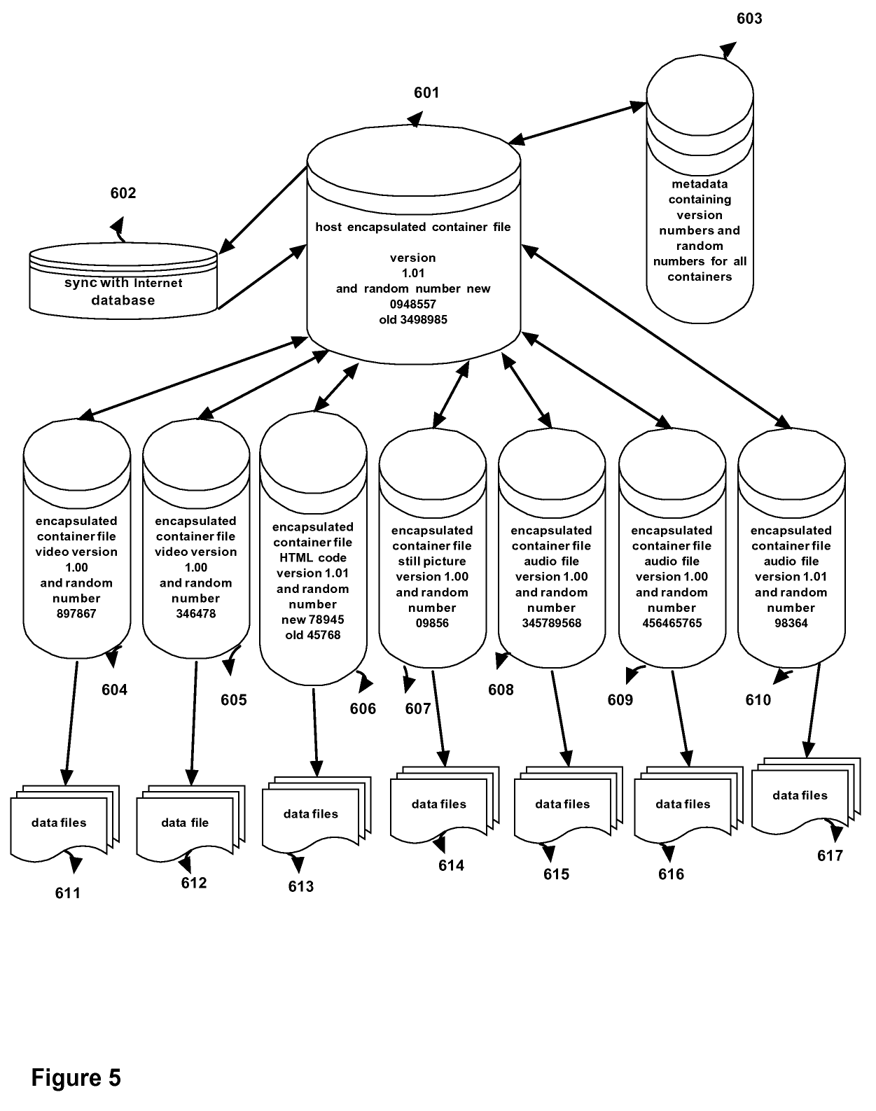

(5) FIG. 5 is a pictorial flow chart documenting the result of the structure explained in FIG. 4 after an update has taken place.

### DESCRIPTION OF THE PREFERRED EMBODIMENT

Some parts contained within the pictorial flow chart figures many contain process instances shared in multiple examples

FIG. 1 represents a user's interaction with an interactive client for the duty of preparing a file container in specification to this invention:

(1) 201 is the start of the process;

(2) 202 represent the input of binary video files;

(3) 203 determine the statistics of the video stream;

(4) 204 is a process of encoding the file to comply with a pre determined specification;

(5) 205 offer a preview of the sequencing binary video files;

(6) 206 represent a process of creating a binary image used to create recordable optical disc transfers;

(7) 207 is a client executed command that is the result of a successful micro payment for additional burn rights;

(8) 208 represents a verification process which compares the binary sector contents of the burned media with the temporary image created to burn it on the hard drive;

(9) 209 represents the a client command which executes the task of subtracting a burn right from the project files metadata record;

(10) 210 represent a continuation command from the client after a successful transaction for additional burn rights;

(11) 211 represent the opposite command of FIG. 1—209;

(12) 212 is a client command to record disc burning report back to the project's metadata;

(13) 213 represent the end of a successful disc burning transfer;

(14) 214 represent acknowledgment of a successful payment;

(15) 215 represent acknowledgment that a micro payment is needed by the client;

(16) 216 represent the client's decision to process a micro payment for burn rights

(17) 217 represent the client's task of reading and writing of available burn rights;

(18) 218 represent the client's ability to transfer a metadata file containing the preferences and configurations set by all users;

(19) 219 represents input of binary audio files

(20) 220 is an interface used to extract CDs into the client's interface for authoring, with security features built in utilizing CDDB databases to determine non extraction of previously copyrighted material, content owners of previously released material can offer affiliate programs by registering with the proprietary company and update of CDDB referenced information contained within a section of a internet database;

(21) 221 is an audio preview interface which allows manual and sequential playback preview of audio assets set for containment;

(22) 222 represents a first generation file container used for client system archive proprietary to the matching IP address of the client's reading IP address and the stored IP address on this first generation file container;

(23) 223 represent a verification check applet of the client to determine the frequency requirements according to the specifications of the project in preparation;

(24) 224 represents a logically saved file container of the first generation file save manually by the author as traditional with standard save functions of interactive applications;

(25) 225 represent a logically saved file container of the first generation file saved automatically every five minutes for the purpose of a fail safe backup of the progression of the project;

(26) 226 represent the programming of the file container's metadata file contents comprising: micro payment account details, preferred micro payment price, author's system password, authorizing random number, authors IP address;

(27) 227 represent the user's decision to record a disc;

(28) 228 represents the process of the addition of a royalty fee which can comprise more than one recipient dictated by a monetary amount or a percentage input for automated calculation by the client, also affiliate royalties are determined here;

(29) 229 represents the process of creating a magnet link for use with proprietary use of the client's server features across close proprietary, popular peer to peer and torrent networks not allowing access to files not associated with this proprietary system;

(30) 230 represent the process of creating a random number for use in the validation process of the client when the author decides to establish micro payment features;

(31) 231 represents the background process of the client's register of the generated random number with the first generation file container's metadata awaiting user input to allow the next step of distribution preparation;

(32) 232 represents the creation of the second generation file container generated from the first generation file container with the embedded metadata and all files sub contained wrapped in file containers with similar metadata in relation to their contents ultimately structured for the ability to update and upgrade the contents from a remote location; and

(33) 233 represents access to an internet database that records all of the client generated file containers and contents contained.

FIG. 2 represents the process of data transfer in this proprietary system where as:

(1) 301 represent the request for transfer by an end user;

(2) 302 represent the content owner's client in server mode;

(3) 303 represents a back up ftp access location as referenced in a secondary field of the magnet link;

(4) 304 represents access to third party recipients running server clients accessible through the instant messaging client and peer to peer network integration in the client;

(5) 305 represent a wireless capable local area network with access to the internet;

(6) 306 represents an internet database that records and transmit information regarding client use across the proprietary community;

(7) 307 represent the end user client and server

(8) 308 represents the action of opening a file container on an end user's client after a successful transition from the content provider, at which user can access a non payment version and an option for access to a paid version;

(9) 309 represent the process of metadata programming of the end users client to determine the burn rights and micro payment amounts available for execution;

(10) 310 represents the permissions finally set depending on payment or non payment by the end user; and

(11) 311 represents the process of “new version” check with the content provider adjusted according to seek controls available in the preferences of the end users client.

FIG. 3 represents the data sequence programmed into a file container's metadata and the execution of the client to execute processing in tandem with the assets contained internally within this host file container where as:

(1) 401 represent a start command executed by the user using an open command on a file link;

(2) 402 represent the host file container;

(3) 403 represent the internal metadata control file of the file container;

(4) 404 through 412 represent as sequence of diverse binary multimedia and internet dependant streaming links;

(5) 413 through 415 represent binary files enclosed in file containers for access by the client according to the sequenced data flow as defined by the host file container's metadata;

(6) 416 represent a start command by the user of the client application;

(7) 417 represent the graphic user interface of the proprietary client;

(8) 418 represents a wireless capable local area network with access to the internet; and

(9) 419 represents recording task of the client to a dedicated internet database.

FIG. 4 and FIG. 5 represents the relation of the host file container to the sub file containers and the use of version numbers and random numbers to update assets between two deferent file containers syncing to each other where as:

FIG. 4 comprises references in which;

(1) 501 represent the host file container with current version number and random number;

(2) 502 represent sync with a dedicated internet database;

(3) 503 represent the control metadata of the host file container which records all data in relation to the host and sub file containers;

(4) 504 through 509 represents sub file containers with version numbers and random numbers; and

(5) 510 through 515 represents binary data files contained within the sub file containers which are not accessible in any way and not playable in applications outside of the file container in a proprietary authorized user client.

FIG. 5 comprises references in which;

(1) 601 represent an updated version of 501 with a record of a new version number, a new random number, and a record of the old random number;

(2) 602 represent sync with a dedicated internet database;

(3) 603 represent the control metadata of the host file container which now contains updated data in relation to the host and sub file containers;

(4) 604 and 605 represents unchanged sub file containers from 504 and 505;

(5) 606 represent an updated version of 506 whereas given a new version number, a new random number, and a record of the old random number;

(6) 608 and 609 represents unchanged sub file containers from 508 and 509;

(7) 610 represents a new addition to the file container contents represented by the version number reflective of the generation added and a random number; and

(8) 611 through 61 7 represents binary data files contained within the sub file containers which are not accessible in any way and not playable in applications outside of the file container in a proprietary authorized user client

What is claimed is:

1. A system of commerce and distribution in which users operate an interactive authoring and serving client used to create sequences of data flow archived for future retrieval as a session file in the form of an encapsulated container used to read, write, and transfer content consisting of interchangeable assets and modular structures comprised of standard and non standard formats comprising use for local access, remote access and recordable media.

2. The system of commerce and distribution of claim 1, wherein said system of commerce is comprised of a successful data transfer session before the receiving user is given an option to make a payment which is rendered by way of general micro payments, royalty micro payments, and affiliate micro payments embedded in a metadata file included with multiple binary sources contained in individual proprietary encapsulated containers with version numbers, random numbers inside a host proprietary encapsulation container with a version number and a random number resulting in a traditional software application construction.

3. The system of commerce and distribution of claim 2, wherein said distribution is delivered digitally utilizing an embedded download manager inside the authoring and serving client capable of delivering a request that can survive through unfortunate conditions such as power outages, system failures, transfer disconnections, and user errors to ultimately guarantee successful transfers of data transferring sessions ranging from 1 kilobyte to 1000 terabytes using methods comprising digital data transferring agents and wireless capable local and dynamic area networks before any required payments are to be rendered.

4. The system of commerce and distribution of claim 2, wherein content preparation is comprised of payment accessible binary multimedia content, and non payment reviewable content relieving the strict demand for payment by embedding two versions of accessible content with one version viewable with payment and another version viewable without payment.

5. The system of commerce and distribution of claim 4, wherein binary multimedia content comprises:
a binary video file;
a binary audio file;
a internet dynamic link; and
a binary still picture file.

6. The system of commerce and distribution of claim 5, wherein the binary video source is comprising:
a binary avi file;
a binary mpeg file;
a binary vob file;
a binary dv file;
a binary divx file;
a binary streaming html file;
a binary streaming url internet link;
a binary flash file; and
a binary shockwave file.

7. The system of commerce and distribution of claim 5, wherein the audio source is comprising:
a binary wav file;
a binary aiff file;
a binary mp3 file; and
a binary flac file.

8. The system of commerce and distribution of claim 5, wherein the internet dynamic link comprises:
a url link;
an html link;
a magnet link;
a torrent file;
an ftp link.

9. The system of commerce and distribution of claim 5, wherein the still picture source comprises images of at least 1 6 colors and above.

10. The system of commerce and distribution of claim 2, wherein the client used to create encapsulated containers also operates as a server and a multimedia playback client.

11. The system of commerce and distribution of claim 10, wherein encapsulated containers are comprised of proprietary and non proprietary data.

12. The system of commerce and distribution of claim 10, wherein data in encapsulated containers are updateable by syncing the data contained within at least 2 encapsulated containers in reference with each other.

13. The system of commerce and distribution of claim 12, wherein the encapsulated data container is defined by a version number.

14. The system of commerce and distribution of claim 10, wherein the data of the encapsulated container is comprised of stationary and interchangeable content.

15. The system of commerce and distribution of claim 10, wherein the encapsulated data container is self executable.

16. The system of commerce and distribution of claim 10, wherein the serving client comprises:
a peer to peer network;
a download manager;
an ftp link;
an html internet source;
an internet url address;
an instant messaging client.

17. The system of commerce and distribution of claim 1, wherein standard and non standard formats for local access and recordable media comprises:
a compact disc recordable;
a digital versatile disc recordable;
a blue laser disc recordable;
a removable memory unit;
a logical hard drive unit;
a holographic disc recordable; and
a universal media disc recordable.

18. The system of commerce and distribution of claim 4, wherein the method of digital distribution comprises methods of recording a metadata file for input and output of passwords, cycle redundant checksum data, random numbers, micro payment pricing, version numbers, email addresses, lyrics, song names, video names, instant messenger screen names, picture pointers, and ip addresses.

19. The system of commerce and distribution of claim 5, wherein multimedia content is comprised in a modular sequencing play order in sequential or random playback schemes according to source.

20. The system of commerce and distribution of claim 18 wherein the information recorded to the metadata file is accessible from multi user clients and recorded simultaneously to an internet database.
